(19) United States
(12) Patent Application Publication
(10) Pub. No.: US 2003/0088396 A1
(43) Pub. Date: May 8, 2003

(54) Apparatus in an ICE system

(76) Inventor: Kuan Chou Chen, Chia Li Town (TW)

Correspondence Address: BIRCH STEWART KOLASCH & BIRCH, PO BOX 747, FALLS CHURCH, VA, 22040-0747, US

(21) Appl. No.: 10/286,882

(22) Filed: Nov. 4, 2002

(30) Foreign Application Priority Data
Nov. 6, 2001 (TW) 090127617

(51) Int. Cl. G06F 9/455

(52) U.S. Cl. 703/28

(57) ABSTRACT

An apparatus in an ICE system is disclosed, which uses the buses connected to the ICE to access data from an external memory. The apparatus includes a first buffer, a second buffer, a higher-bit address bus, a lower-bit-address/data multiplexing bus, a lower-bit address bus, and a control unit. The first buffer transmits the signal of the higher-bit address bus of the ICE to the higher-bit address bus when the buffer enable signal is enabled. The second buffer transmits or receives the signal of the address/data multiplexing bus of the ICE to and from the lower-bit-address/data multiplexing bus when the buffer enable signal is enabled. The control unit receives control signals of the ICE and generates the buffer enable signal and the direction control signal. The buffer enable signal is enabled when an address-latch-enable signal of the ICE is enabled, and is disabled when a higher-bit address bus signal of the ICE does not fall within a predetermined range. Because the apparatus uses the buses connected to the ICE to access data from an external memory, the I/O pins can be reduced.

### BACKGROUND OF THE INVENTION

1. Field of the Invention

The invention relates to an apparatus in an ICE system, and more specifically to an apparatus for accessing external memory data using the address/data bus connected to an in-circuit emulator (ICE) in an ICE system.

2. Description of the Related Art

In some in-circuit emulators (herein after ICE), a lower-bit address bus and a data bus are multiplexed as a lower-bit address/data bus to reduce the total I/O pins of the ICE. FIG. 1 shows an ICE control system with such a lower-bit address/data multiplexing bus. As shown in the drawing, because the apparatus 12 may also include a central processing unit (CPU), in addition to be controlled by the ICE 11, the apparatus 12 may further access the data from the external memory 13 by another set of address and data buses. The ICE 11 drives the higher-bit address signal (A15:8), which may include a chip-selection signal CS, for the apparatus 12 to access the data to and from the apparatus 12. For example, when the higher-bit address signal (A15:8) falls within a predetermined range (such as, when the higher-bit address signal falls within the range from F8H to FFH), the chip-selection signal CS for the apparatus 12 is enabled and the apparatus 12 will respond the current read or write cycle issued from the ICE 11. On the other hand, when the higher-bit address signal (A15.8) does not fall within a predetermined range, the apparatus 12 will ignore all activities present on the address bus and address/data multiplexing bus of the ICE 11.

Since the apparatus 12 further includes an independent CPU, the apparatus 12 may read the data from the external memory 13. When the apparatus 12 is reading the data stored in the external memory 13, it is necessary to use another set of data and address buses.

As a result, totally two sets of address and data buses are required for the apparatus 12. The first set is dedicated for ICE 11, while the other set is dedicated for ROM 13. In such a design, the pin number of the apparatus 12 cannot be reduced, thereby increasing the cost.

### SUMMARY OF THE INVENTION

In view of the above-mentioned problems, an object of the invention is to provide an apparatus in an ICE system. The apparatus reads the external memory data using the address bus and the address/data multiplexing bus originally dedicated for the ICE. Accordingly, the I/O pin number of the apparatus may be decreased.

To achieve the above-mentioned object, the apparatus of the invention includes a first buffer, a second buffer, a higher-bit address bus, a lower-bit address/data multiplexing bus, a lower-bit address bus, and a control unit. The first buffer receives a higher-bit address signal from the ICE and is controlled by a buffer enable signal. The first buffer is turned on when the buffer enable signal is enabled. The second buffer is connected to the lower-bit address/data multiplexing bus of the ICE and is controlled by the buffer enable signal and a direction control signal. The second buffer is turned on when the buffer enable signal is enabled. The higher-bit address bus is connected to an output terminal of the first buffer and to the higher-bit address bus of the external memory. The lower-bit address/data multiplexing bus of the apparatus is connected to a first terminal of the second buffer and to the data bus of the external memory. The lower-bit address/data bus of the apparatus is connected to a lower-bit address bus of the external memory. The control unit receives a control signal from the ICE and generates the buffer enable signal and the direction control signal.

The buffer enable signal is enabled when an address-latch-enable ALE signal of the ICE is enabled, and is disabled when a higher-bit address bus signal of the ICE does not fall within a predetermined range.

### BRIEF DESCRIPTION OF THE DRAWINGS

FIG. 1 shows a typical ICE system.

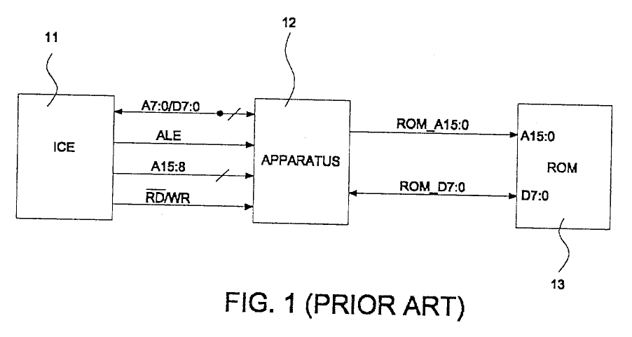

FIG. 2 is an ICE system according to one embodiment of the present invention.

FIG. 3 is a timing diagram showing the condition where the higher-bit address signal A15:8 of the ICE 21 does not fall within a predetermined range.

FIG. 4 is a timing diagram showing the condition where the higher-bit address bus data A15:8 of the ICE 21 falls within a predetermined range and the data stored in the control apparatus 22 is read by the ICE 21.

FIG. 5 is a timing diagram showing the condition where the higher-bit address bus data A15:8 of the ICE 21 falls within a predetermined range and the data is written into the control apparatus 22.

### DETAILED DESCRIPTION OF THE INVENTION

The apparatus for reading data from a ROM in an ICE system of one embodiment will be described with reference to the accompanying drawings.

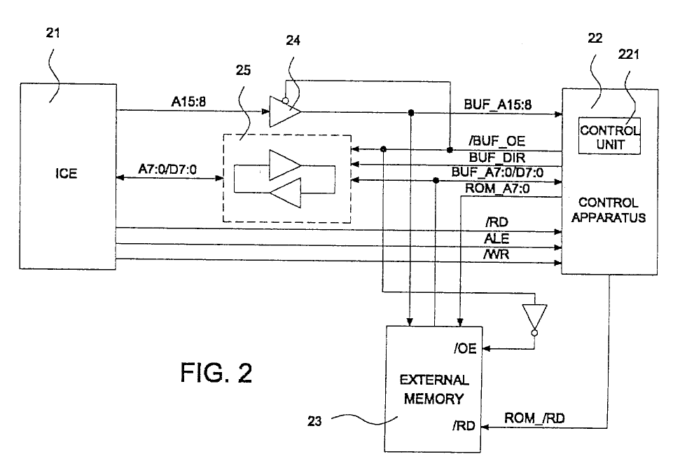

FIG. 2 is a block diagram showing an apparatus used in an ICE system of one embodiment. Referring to FIG. 2, the ICE system includes an in-circuit emulator (ICE) 21, a control apparatus 22, an external memory 23, and two buffers 24 and 25.

The higher-bit address signal A15:8 of the ICE 21 is transmitted to the higher-bit address bus BUF_A15:8 of the control apparatus 22 via the first buffer 24. Meanwhile, the data of the lower-bit address/data multiplexing bus of the ICE 21 is transmitted to the lower-bit address/data multiplexing bus BUF_A7:0/D7:0 of the control apparatus 22 via the second buffer 25. In addition, an address-latch-enable signal ALE, a reading control signal /RD, and a writing control signal /WR of the ICE 21 are directly connected to the control apparatus 22.

The control apparatus 22 decodes the higher-bit address signal A15:8 of the ICE 21 and decides whether the ICE 21 desires to access the control apparatus 22. If the ICE 21 desires to access the control apparatus 22, for example, the address A15.8 provided by the ICE 21 falls within a predetermined range, the control apparatus 22 enables the buffer enable control signal /BUF_OE and sets the buffer-direction control signal BUF_DIR according to the reading control signal /RD or the writing control signal /WR. The buffer enable control signal /BUF_OE is dedicated for controlling the ON/OFF states of the first buffer 24 and the second buffer 25, while the buffer-direction control signal BUF_DIR is dedicated for controlling the transmitting direction of the second buffer 25.

The first buffer 24 is a buffer with single transmitting direction. When the buffer enable control signal /BUF_OE is enabled, the buffer 24 is turned on. When the buffer enable control signal /BUF_OE is disabled, the output terminal of the buffer 24 is kept in a high-impedance state. The second buffer 25 is a bi-directional transmitting buffer. When the buffer enable control signal /BUF_OE is enabled, the buffer 25 is turned on, and the transmitting direction is determined according to the buffer-direction control signal BUF_DIR. When the buffer enable control signal /BUF_OE is disabled, both terminals of the buffer 25 are kept in a high-impedance state.

The higher-bit address bus of the external memory 23 is connected to the higher-bit address bus BUF_A15:8 of the control apparatus 22, while the data bus of the external memory 23 is connected to the address/data multiplexing bus BUF_A7:0/D7:0 of the control apparatus 22. Meanwhile, the lower-bit address bus is connected to the memory address bus ROM_A7:0 of the control apparatus 22. In addition, the control apparatus 22 further outputs a control signal, such as a reading signal ROM_/RD, to the external memory 23. In addition, the external memory 23 is further controlled by the inverted signal of the buffer enable control signal /BUF_OE. That is, the external memory 23 is enabled only when the buffer enable control signal /BUF_OE is disabled.

The control apparatus 22 also includes a control unit 221 for generating the buffer enable control signal /BUF_OE and the buffer-direction control signal BUF_DIR. The buffer enable control signal /BUF_OE is generated by decoding the higher-bit address signal A15:8 of the ICE 21, while the buffer-direction control signal BUF_DIR is generated according to the reading control signal /RD or the writing control signal /WR. When the higher-bit address signal A15:8 of the ICE 21 does not fall within a predetermined range, the buffer enable control signal /BUF_OE of the control apparatus 22 is disabled. At the rising edge of the next address-latch-enable signal ALE, the decoding of higher-bit address signal and subsequent operation are performed again.

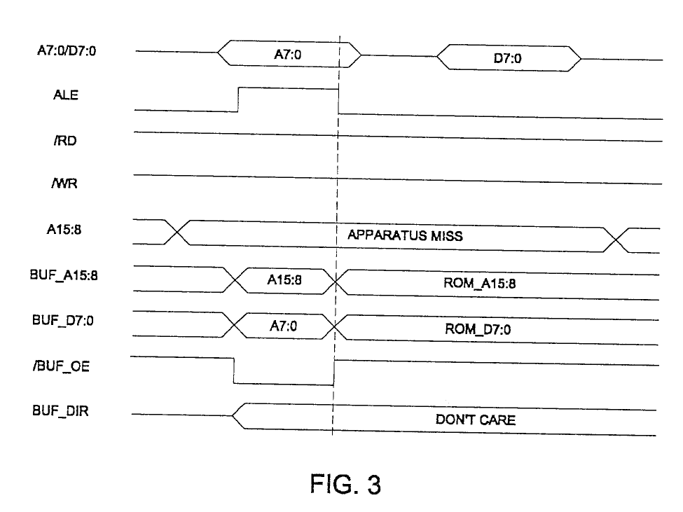

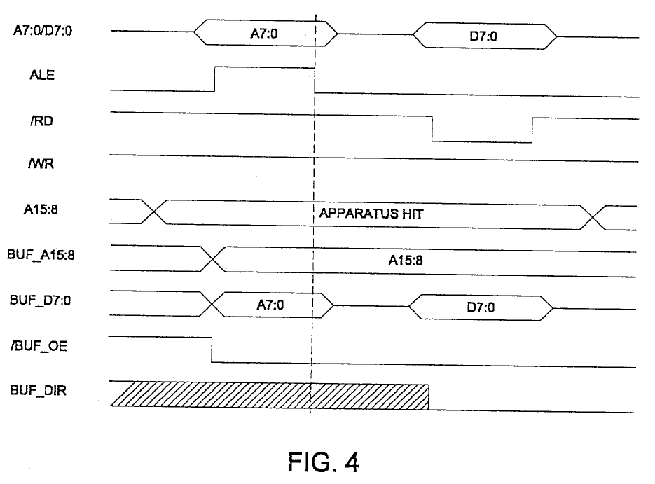

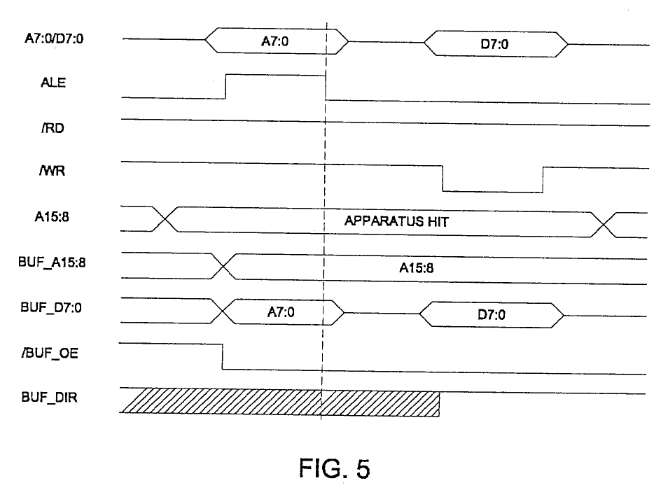

The operation of each control signal will be described with reference to FIGS. 3 to 5. FIG. 3 is a timing diagram showing the condition that the higher-bit address signal A15:8 of the ICE 21 does not fall within a predetermined range. FIG. 4 is a timing diagram showing the condition that the higher-bit address signal A15:8 of the ICE 21 falls within a predetermined range and the reading control signal /RD is enabled. FIG. 5 is a timing diagram showing the condition that the higher-bit address signal A15:8 of the ICE 21 falls within a predetermined range and the writing control signal /WR is enabled.

As shown in FIG. 3, at the rising edge of the address-latch-enable signal ALE of the ICE 21, the buffer enable control signal /BUF_OE of the control apparatus 22 is enabled. Therefore, the data inputted to the buses BUF_A15:8 and BUF_A7:0/D7:0 of the control apparatus 22 are the higher-bit address signal A15:8 and lower-bit address signal A7:0 of the ICE 21, respectively. At this time, the control apparatus 22 decodes the higher-bit address signal A15:8 to decide whether the higher-bit address signal A15:8 falls within a predetermined range. Because the address signal A15:8 does not fall within a predetermined range, the buffer enable control signal /BUF_OE is disabled at the falling edge of the address-latch-enable signal ALE. Since the buffer enable control signal /BUF_OE is disabled, the state of the buffer-direction control signal BUF_DIR does not matter. After the buffer enable control signal /BUF_OE is disabled, the control apparatus 22 can read data from the external memory 23 via the BUF_A15:8 and BUF_A7:0/D7:0 buses. That is, the control apparatus 22 can send the desired address to the external memory 23 via the buses BUF_A15:8 and ROM_A7:0, and read data via the bus BUF_A7:0/D7:0. In addition, the control apparatus 22 can control the accessing process according to the control signal ROM_/RD.

Next, as shown in FIGS. 4 and 5, the buffer enable control signal /BUF_OE of the control apparatus 22 is enabled at the rising edge of the address-latch-enable signal ALE of the ICE 21. Therefore, the data inputted to the buses BUF_A15:8 and BUF_A7:0/D7:0 of the control apparatus 22 are the higher-bit address signal A15:8 and lower-bit address signal A7:0 of the ICE 21, respectively. At this time, the control apparatus 22 decodes the address signal A15:8 to decide whether the higher-bit address siganl A15:8 falls within a predetermined range. Because the higher-bit address signal A15:8 falls within the predetermined range, the buffer enable control signal /BUF_OE is continuously enabled. Consequently, the ICE 21 can access the data of the control apparatus 22 via the buses BUF_A15:8 and BUF_A7:0/D7:0. FIG. 5 is similar to FIG. 4, except that the control signal /RD and /WR are different, so the related description of FIG. 5 is omitted for the sake of brevity.

In this way the higher-bit address bus BUF_A15:8 and the address/data multiplexing bus BUF_A7:0/D7:0 of the control apparatus 22 are used by the ICE 21 and the external memory 23 at different stages. Therefore, comparing to the convention art, although the control apparatus 22 has to provide two additional pins for providing the buffer enable control signal /BUF_OE and the buffer-direction control signal BUF_DIR, the number of overall I/O pins of the control apparatus is still reduced.

While certain exemplary embodiment has been described and shown in the accompanying drawings, it is to be understood that such embodiment is merely illustrative of and not restrictive on the broad invention, and that this invention not be limited to the specific construction and arrangement shown and described, since various other modifications may occur to those ordinarily skilled in the art.

What is claimed is:

1. An apparatus used in an in-circuit emulator system, the apparatus utilizing a first and a second buses connected to an in-circuit emulator (ICE) to read data from an eternal memory, the apparatus comprising:
a first buffer connected to the first bus of the ICE, the first buffer being controlled by a buffer enable signal;
a second buffer connected to the second bus of the ICE, the second buffer being controlled by the buffer enable signal and a direction control signal;
a third bus connected to the first buffer and to a fourth bus of the external memory;
a fifth bus connected to the second buffer and to a sixth bus of the external memory; and
a control unit for receiving control signals from the ICE and generating the buffer enable signal and the direction control signal.

2. The apparatus according to claim 1, wherein the control signals of the ICE comprise an address-latch-enable signal, a reading signal /RD and a writing signal /WR.

3. The apparatus according to claim 2, wherein the buffer enable signal is enabled when the address-latch-enable signal of the ICE is enabled, and is disabled when the address of the ICE does not fall within a predetermined range.

4. The apparatus according to claim 2, wherein the second buffer transmits the signal of the fifth bus of the apparatus to the second bus of the ICE when the reading control signal of the ICE is enabled and the buffer enable signal is also enabled.

5. The apparatus according to claim 2, wherein the second buffer transmits the signal of the second bus of the ICE to the fifth bus of the apparatus when the writing control signal of the ICE is enabled and the buffer enable signal is also enabled.

6. The apparatus according to claim 1, wherein the apparatus further outputs a reading control signal to the external memory.

7. The apparatus according to claim 1, wherein the apparatus further outputs the buffer enable signal to the external memory so as to enable the external memory when the buffer enable signal is disabled.

8. An in-circuit emulator (ICE) system, comprising:
a bi-directional buffer having a first terminal and a second terminal;
an ICE having a first address port connecting to an input terminal of a first buffer, and a first address/data multiplexing port connecting to the first terminal of the bi-directional buffer;
a control apparatus having a second address port connecting to an output terminal of the first buffer, a second address/data multiplexing port connecting to a second terminal of the bi-directional buffer, and a third address port;
a memory having a fourth address input port connecting to the output terminal of the first buffer, a fifth address input port connecting to the third address port, and a first data port connecting to the second terminal of the bi-directional buffer;
wherein when the control apparatus needs to access the memory, the control apparatus sends address signals to the memory by the third address port and receives data signals from the memory by the second address/data multiplexing port.

9. The in-circuit emulator (ICE) system according to claim 8, wherein the control apparatus further comprises a control unit for generating a buffer enable control signal to enable the first buffer.

10. The in-circuit emulator (ICE) system according to claim 9, wherein the control unit decodes data signals originated from the first address port of the ICE to generate the buffer enable control signal.

11. The in-circuit emulator (ICE) system according to claim 9, wherein when data signals originated from the first address port of the ICE falls within a predetermined range, the control unit generates the buffer enable control signal to enable the first buffer.

12. The in-circuit emulator (ICE) system according to claim 8, wherein the control apparatus further comprises a control unit for generating a buffer disable control signal to disable the first buffer when the data signals originated from the first address port of the ICE falls outside a predetermined range.

13. The in-circuit emulator (ICE) system according to claim 8, wherein the control apparatus further comprises a control unit for generating a buffer-direction control signal to control a transmission direction of the bi-directional buffer.

14. The in-circuit emulator (ICE) system according to claim 11, wherein the ICE further provides a reading control signal to the control apparatus, the control unit generates the buffer-direction control signal according to the reading control signal.

15. The in-circuit emulator (ICE) system according to claim 11, wherein the ICE further provides a writing control signal to the control apparatus, the control unit generates the buffer-direction control signal according to the writing control signal.

16. The in-circuit emulator (ICE) system according to claim 8, wherein when the control apparatus needs to access the memory, the control apparatus further sends a memory enable signal to enable the memory.

17. The in-circuit emulator (ICE) system according to claim 9, wherein the buffer enable control signal is also used to control activation of the memory.
